(19) United States
(12) Patent Application Publication
(10) Pub. No.: US 2024/0119561 A1
(43) Pub. Date: Apr. 11, 2024

(54) IMAGE PROCESSING DEVICE AND IMAGE PROCESSING METHOD

(71) Applicant: LG INNOTEK CO., LTD., Seoul (KR)

(72) Inventors: Se Mi JEON, Seoul (KR); Jung Ah PARK, Seoul (KR)

(73) Assignee: LG INNOTEK CO., LTD., Seoul (KR)

(21) Appl. No.: 17/766,589

(22) PCT Filed: Oct. 8, 2020
(86) PCT No.: PCT/KR2020/013814

§ 371 Date: Apr. 5, 2022

(30) Foreign Application Priority Data
Oct. 14, 2019 (KR) 10-2019-0126884

(51) Int. Cl. G06T 3/4076; G06V 10/56; G06V 10/60

(52) U.S. Cl. CPC G06T 3/4076; G06V 10/56; G06V 10/60

(57) ABSTRACT

An image processing device according to an embodiment comprises: a first processing unit for outputting second Bayer data having a second resolution from first Bayer data having a first resolution; a second processing unit for outputting second IR data having a fourth resolution from first IR data having a third resolution; and an image processing unit for outputting a second RGB image by calculating a first RGB image generated from the second Bayer data and an IR image generated from the second IR data.

### TECHNICAL FIELD

The present invention relates to an image processing device, and more particularly, relates to an image processing and an image processing method for generating high resolution Bayer data from low resolution Bayer data using a deep learning algorithm, and improving the low luminance of an RGB image by using an IR image.

### BACKGROUND ART

As technology advances and miniaturization of camera modules becomes possible, small camera modules are being applied to and used in various IT devices such as smartphones, mobile phones, PDAs, and the like. Such a camera module is manufactured using an image sensor such as CCD or CMOS as a main component, and is manufactured to enable focus adjustment in order to adjust the size of an image.

Such a camera module is configured to include a plurality of lenses and an actuator, and an object with respect to the subject can be photographed in a manner in which an optical focal length is adjusted when the actuator moves each lens to change the relative distance.

Specifically, the camera module includes an image sensor that converts an optical signal received from the outside into an electrical signal, a lens that focuses light onto the image sensor, an infrared (IR) filter, a housing including them, and a printed circuit board that processes the image sensor signal, and the like, and the actuator adjusts the focal length of the lens by an actuator such as a voice coil motor (VCM) actuator or a micro electromechanical systems (MEMS) actuator.

Meanwhile, as technology advances and enables the realization of high resolution images, the demand for technologies capable of realizing high resolution images of distant objects is also increasing.

In general, cameras are equipped with a zoom function to photograph pictures of distant objects. the zoom function is largely divided into an optical zoom in which the actual lens inside the camera moves to magnify the subject and a digital zoom method in which zoom effect is achieved by enlarging a portion of an image data of the photographed subject using a digital processing method.

In the case of optical zoom, which obtains an image of a subject by using a lens movement, an image having a relatively high resolution can be obtained, but there is a problem in that the internal structure of the camera is complicated and the cost increases due to the addition of parts. In addition, there is a limit to an area in which a subject can be enlarged by using an optical zoom, and for this part, a technology for correcting with software is being developed.

In addition to these methods, technologies exist to implement high resolution images by generating more pixel information by moving parts inside the camera, such as a sensor shift technology that shakes the sensor with voice coil motor (VCM) or micro-electro mechanical systems (MEMS) technology, an optical image stabilizer (OIS) technology that obtains pixel information by shaking the lens with VCM and the like, and a technology that shakes the filter between the sensor and the lens, and the like.

However, the disadvantage of these technologies is that, when photographing a moving object, phenomena such as motion blur or artifacts may occur because they synthesize data of several parallaxes, which causes the problem of degrading the image quality.

In addition, there are problems in that the size of the camera module increases as a complicated device for implementing this is inserted into the camera, it is difficult to use in a vehicle in which the camera is installed since it is implemented by shaking parts, and it can be used only in a stationary environment.

On the other hand, as a high resolution implementation technology using a software algorithm generally used in TVs, there are technologies such as a single-frame super resolution (SR) or a multi-frame super resolution (SR), and the like.

In the case of these technologies, there is no artifact problem, but it is an algorithm that is difficult to apply to devices to which small camera modules such as mobile device, vehicle, IoT, and the like can be applied, and in addition, there is a problem that is difficult to implement unless a separate image processor is mounted in order to implement such a technology.

In addition, an RGB camera generally mounted in a mobile device has a problem in that the image quality is poor because the brightness is very low or the noise is severe when photographing an image in a low luminance environment. As a way to improve the image quality of RGB cameras in low light environments, the flash function can be used. However, when the flash function is used, it may be difficult to obtain a natural image because the light is saturated at a near distance where the flash is being illuminated. Another way to improve the image quality of an RGB camera in a low luminance environment is to use an IR sensor with the RGB camera. However, the sensitivity to RGB colors may be degraded due to the IR sensor. Accordingly, there is a need for a new method for improving the image quality of an RGB camera in a low light environment.

In addition, as the need for 3D cameras in smartphones increases, new applications are provided in conjunction with existing RGB cameras. As the 3D camera is applied to the technology that was previously limited only by RGB color technology, the added value of existing functions is also increasing. However, due to the large difference in resolution between the two types of cameras, efforts are being made to change the hardware (HW) structure to increase the 3D resolution or to develop a ToF sensor with a higher resolution.

The resolution of RGB cameras currently installed in smartphones has been gradually increasing, and even sensors of 40 MP or higher are emerging. However, the resolution of ToF or structured light 3D cameras, except for stereo, is still at the level of VGA. Since the stereo method uses two RGB cameras, the resolution is high, but the distance resolution is low, and therefore, ToF or structured light methods are often used for distance accuracy. These two methods require a light emitting part (e.g., VCSEL) that emits light, which emits an IR signal and the receiver (sensor) receives this IR signal to calculate the distance by comparing the time or pattern. Since there is an IR signal, the receiver can create an IR image therefrom. In particular, ToF can generate an IR image in the form of an image that we often see with an IR camera.

When two images are used together, the resolution of the two images is so different that only a portion of it can be utilized, so it is necessary to increase the resolution of the ToF.

### DETAILED DESCRIPTION OF THE INVENTION

### Technical Subject

A technical subject to be solved by the present invention is to provide an image processing device and an image processing method for generating high resolution Bayer data or IR data by performing deep learning and improving the quality of an RGB image by using the IR data.

### Technical Solution

In order to solve the above technical subject, an image processing device according to an embodiment of the present invention comprises: a first processing unit for outputting second Bayer data having a second resolution from first Bayer data having a first resolution; a second processing unit for outputting second IR data having a fourth resolution from first IR data having a third resolution; and an image processing unit for outputting a second RGB image by calculating a first RGB image generated from the second Bayer data and an IR image generated from the second IR data.

In addition, the first processing unit may include a first convolutional neural network that has been learned to output the second Bayer data from the first Bayer data, and the second processing unit may include a second convolutional neural network that has been learned to output the second IR data from the first IR data.

In addition, the first Bayer data may be data being outputted from the image sensor, and the first IR data may be data being outputted from the ToF sensor.

In addition, the frame rate per hour of the ToF sensor may be faster than the frame rate per hour of the image sensor.

In addition, the image processing unit may generate the second RGB image by using a result value calculated by calculating the reflection component of the first RGB image and the IR image and hue component and chroma component of the first RGB image, correct the IR image before performing the operation with the first RGB image, generate the first RGB data from the second Bayer data, and generate the IR image from the second IR data.

In addition, the IR image generated by the image processing unit may be an amplitude image or an intensity image generated from the second IR data according to four different phases being generated by the second processing unit.

In addition, the first processing unit includes at least one line buffer for storing the first Bayer data for each line, and when a first Bayer data of a predetermined number of lines is stored in the line buffer, it may perform generation of a second Bayer data for the first Bayer data stored in the line buffer.

In addition, the first processing unit outputs the second Bayer data from the first Bayer data using a first parameter derived through training for Bayer data processing, and the second processing unit may output the second IR data from the first IR data using a second parameter derived through training for IR data processing.

In addition, the first processing unit and the second processing unit may be formed on an image sensor module, a camera module, or an AP module.

In addition, the second resolution may be higher than the first resolution, the fourth resolution may be higher than the third resolution, and the second resolution and the fourth resolution may be the same.

In order to solve the above technical subject, an image processing device according to another embodiment of the present invention comprises: a third processing unit generating second Bayer data having a second resolution from the first Bayer data having a first resolution and generating second IR data having a fourth resolution from the first IR data having a third resolution; and an image processing unit generating second RGB image by calculating a first RGB image being generated from the second Bayer data and an IR image being generated from the second IR data.

In addition, the third processing unit may perform the generation of the second Bayer data and the generation of the second IR data by time division multiplexing.

In order to solve the above technical subject, an image processing device according to another embodiment of the present invention comprising: a fourth processing unit for generating second IR data having a fourth resolution from first IR data having a third resolution; and an image processing unit for generating second RGB image by calculating a first RGB image being generated from Bayer data and an IR image being generated from the second IR data.

In order to solve the above technical subject, an image processing method according to an embodiment of the present invention comprising the steps of: generating second Bayer data having a second resolution from the first Bayer data having a first resolution; generating second IR data having a fourth resolution from the first IR data having a third resolution; generating first RGB image from the second Bayer data; generating an IR image from the second IR data; and generating second RGB image by calculating the first RGB image and the IR image.

In order to solve the above technical subject, an image processing method according to another embodiment of the present invention comprising the steps of: generating second IR data having a fourth resolution from the first IR data having a third resolution; generating first RGB image from Bayer data; generating an IR image from the second IR data; and generating a second RGB image by calculating the first RGB image and the IR image.

### Advantageous Effects

According to embodiments of the present invention, in generating a high resolution RGB image, since digital zoom is performed by increasing the resolution of Bayer data, which is raw data, not an RGB image, a high resolution image with high image quality can be obtained due to a large amount of information compared to the case of increasing the resolution for the RGB image.

In addition, by increasing the resolution of the ToF IR image and merging it with the RGB image, the effect of improving low luminance of RGB can be increased. There is no need to add an additional configuration, and RGB images with excellent image quality can be obtained in a low luminance environment even without significantly increasing the amount of computation,

Furthermore, an RGB image with improved image quality can be generated while increasing the resolution of the RGB image.

In addition, high resolution is implemented in a way that only a few line buffers is used, and high resolution images are generated in a way that the network configuration is optimized so that it can be implemented with a small chip with a relatively small size, and through this, it can be mounted in various places in various ways depending on the purpose of use of the mounted device, and therefore the degree of freedom in design can be increased. In addition, since expensive processors are not required to perform conventional deep learning algorithms, high resolution images can be produced more economically.

In addition, since the implementation of this technology is possible in a way that can be mounted anywhere such as an image sensor module, a camera module, and an AP module, continuous zoom function can be used by applying this technology to various existing modules, such as a camera module without a zoom function or a camera module that only supports fixed zoom for a specific magnification.

In addition, by applying this technology to a camera module that only supports optical continuous zoom for a specific magnification, there is an effect that the continuous zoom function can be utilized in a wider range of magnification.

### BRIEF DESCRIPTION OF DRAWINGS

FIG. 1 is a block diagram of an image processing device according to an embodiment of the present invention.

FIG. 2 is a diagram illustrating an image processing process of an image processing device according to an embodiment of the present invention.

FIGS. 3 to 6 are diagrams for explaining a process of increasing the resolution of Bayer data or IR data.

FIGS. 7 to 11 are diagrams for explaining a process of improving the quality of an RGB image through operation with an IR image.

FIG. 12 is a block diagram of an image processing device according to another embodiment of the present invention.

FIG. 13 is a diagram illustrating an image processing process of an image processing device according to another embodiment of the present invention.

FIG. 14 is a block diagram of an image processing device according to another embodiment of the present invention.

FIG. 15 is a diagram illustrating an image processing process of an image processing device according to another embodiment of the present invention.

FIG. 16 is a flowchart of an image processing method according to an embodiment of the present invention.

FIG. 17 is a flowchart of an image processing method according to another embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

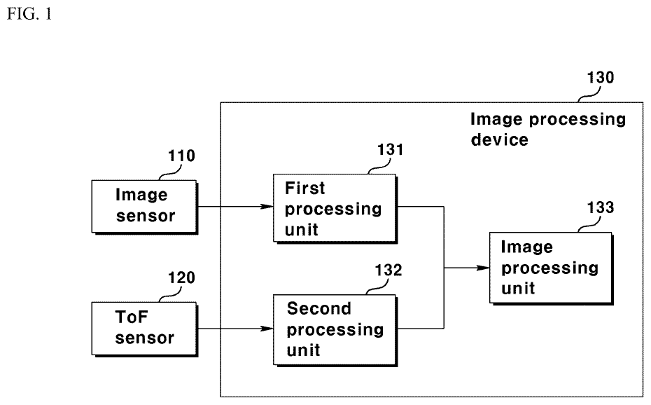

FIG. 1 is a block diagram of an image processing device 130 according to an embodiment of the present invention. The image processing device 130 according to an embodiment of the present invention includes a first processing unit 131, a second processing unit 132, and an image processing unit 133. It may further include one or more memories and a communication unit.

The first processing unit 131 generates second Bayer data having a second resolution from first Bayer data having a first resolution.

More specifically, the first processing unit 131 increases the resolution of Bayer data, which is image data generated and outputted by the image sensor 110. That is, a second Bayer data having a second resolution is generated from the first Bayer data having a first resolution. Here, the second resolution means a resolution having a resolution value different from that of the first resolution, and the second resolution may be higher than the first resolution. The first resolution may be a resolution of Bayer data outputted by the image sensor 110, and the second resolution may be changed according to a user's setting or may be a preset resolution. Here, the image sensor 110 may be an RGB image sensor.

The image processing device 130 may further include an input unit (not shown) for receiving information on the resolution from a user. The user may input information on the second resolution to be generated by the first processing unit 131 through the input unit. For example, if a user wants to obtain a high resolution image, the second resolution may be set to a resolution that is different from the first resolution, and when a new image is to be acquired within a relatively short time, the second resolution may be set to a resolution not significantly different from the first resolution.

In order to perform super resolution (SR), the first processing unit 131 may generate a second Bayer data having a second resolution from first Bayer data having a first resolution. Super resolution is a process of generating a high resolution image based on a low resolution image, and functions as a digital zoom that generates a high resolution image from the low resolution image through image processing rather than a physical optical zoom. Super resolution may be used to improve the quality of a compressed or down-sampled image, or may be used to enhance the quality of an image having a resolution according to device limitations. In addition, it may be used to increase the resolution of an image in various fields.

As in super resolution, when the process of increasing the resolution is performed, the quality of the result of increasing the resolution can be improved by performing the process of increasing the resolution using Bayer data instead of the RGB image. Bayer data is raw data generated and outputted by the image sensor 110 and includes more information than an RGB image generated by image processing. Therefore, increasing the resolution using Bayer data has better processing quality than increasing the resolution using RGB images.

The second processing unit 132 generates a second IR data having a fourth resolution from the first IR data having a third resolution.

More specifically, the second processing unit 132 increases the resolution of IR data, which is data generated and outputted from the ToF sensor 120. That is, a second IR data having a fourth resolution is generated from the first IR data having a third resolution. Here, the fourth resolution means a resolution having a resolution value different from the third resolution, and the fourth resolution may be higher than the third resolution. The third resolution may be a resolution of IR data outputted by the ToF sensor 120, and the fourth resolution may be changed according to a user's setting or may be a preset resolution.

The fourth resolution may be a resolution having the same resolution value as the second resolution. In order to improve the quality of a first RGB image generated from the second Bayer data by using the IR image generated from the second IR data in the image processing unit, which will be described later, the second processing unit 132 may generate the second IR data such that a fourth resolution of the second IR data is the same as a second resolution of the second Bayer data so that the sizes of the IR image and the first RGB image, that is, the resolution is to be the same.

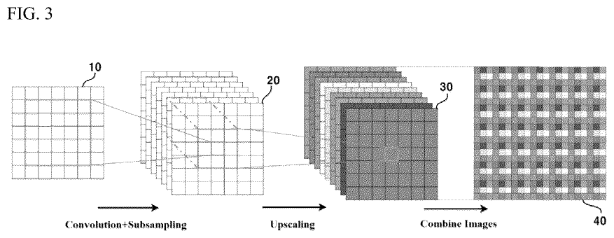

A process of increasing the resolution of data received by the first processing unit 131 or the second processing unit 132 will be described in detail later with reference to FIGS. 3 to 7.

The image processing unit 133 generates a second RGB image by calculating a first RGB image generated from the second Bayer data and an IR image generated from the second IR data.

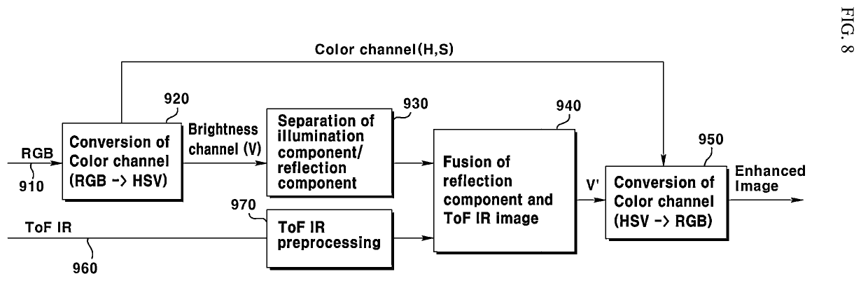

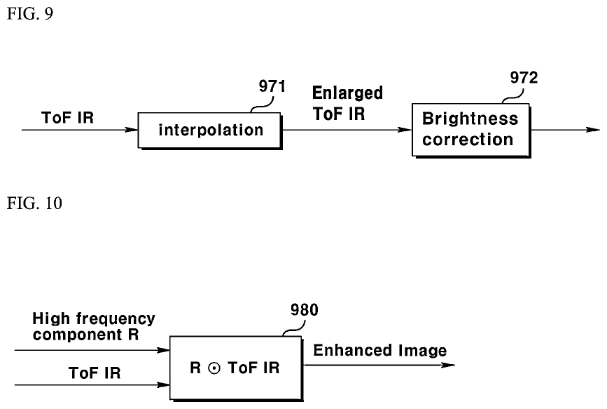

More specifically, the image processing unit 133 generates a second RGB image with improved image quality compared to the first RGB image through the operation of the IR image generated from the second IR data and the first RGB image generated from the second Bayer data. In a low luminance environment, an RGB image created only with Bayer data has low brightness or a lot of noise, so the image quality deteriorates a lot. The image processing unit 133 uses the IR image in order to improve image quality degradation that may occur when generating an RGB image only with Bayer data. That is, a second RGB image with improved image quality is generated by calculating the first RGB image and IR image. A process of generating a second RGB image in which the quality of a first RGB image is improved by using an IR image will be described in detail later with reference to FIGS. 8 to 13.

The image processing device 130 according to an embodiment of the present invention may be applied to an RGB camera device using Bayer data of the image sensor 110 and a 3D camera device using an IR image of the ToF sensor 120, and in addition to the zoom function that increases the resolution of each data, it is possible to improve the low luminance of RGB images by using high resolution IR data. Bayer data or IR data can generate a high resolution RGB image, a high resolution IR image, and a high resolution depth image through the process of increasing the resolution. In addition, since the IR image has a very lower resolution (1 MP or less) than the RGB image, the second processing unit 132 that processes the IR data at a high resolution is suitable to be implemented in the form of a chip. In order to make a miniaturized chip, it is important to minimize the data memory required for algorithm logic and computation, and this is because the resolution of the camera device is directly related to the memory and the amount of computation.

The process of increasing the resolution of the IR data may use a chip included in the RGB camera device that increases the resolution of the Bayer data. It is only necessary to switch the weight values which have been learned to increase the resolution of IR data while using a part of the chip that is incorporated inside the RGB camera device.

When the RGB image in a low luminance situation is improved using the IR image with improved resolution in this way, a higher improvement effect can appear, and when applied to various applications (e.g., face recognition, object recognition, size recognition, and the like), the recognition rate is improved through fusion with depth image.

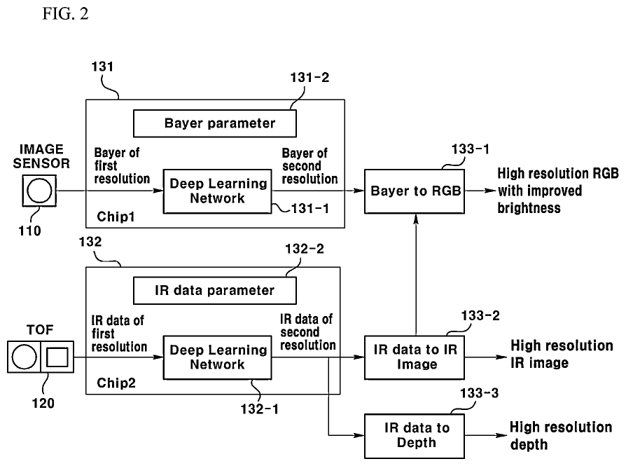

FIG. 2 is a diagram illustrating an image processing process of an image processing device according to an embodiment of the present invention.

The image processing process according to an embodiment of the present invention may be used in an image processing device, a camera device, an image processing method, and an image processing system using a convolutional neural network that has been learned.

The first processing unit of the image processing device according to an embodiment of the present invention may include a first convolutional neural network that outputs a second Bayer data having a second resolution from first Bayer data having a first resolution. The first processing unit may include a pipelined processor and a convolutional neural network that has been learned to generate a second Bayer data from first Bayer data. The first processing unit may output the second Bayer data from the first Bayer data using a first parameter derived through training for Bayer data processing. Here, the first parameter may be referred to as a first deep learning parameter.

A first convolutional neural network according to an embodiment of the present invention is being learned to generate second Bayer data having a second resolution from first Bayer data having a first resolution.

A first convolutional neural network that has been learned may receive the first Bayer data and generate the second Bayer data. Here, the first Bayer data may be Bayer data having a first resolution, and the second Bayer data may be Bayer data having a second resolution. Here, the first resolution may have a resolution different from the second resolution, and the second resolution may be a higher resolution than the first resolution. For example, high resolution Bayer data can be generated from the low resolution Bayer data generated at low luminance.

By generating the second Bayer data using the first convolutional neural network that has been learned, a second Bayer data having a second resolution may be outputted without changing image sensor settings such as zoom magnification, aperture, shutter speed, or the like, or without using a high resolution image sensor. A high resolution Bayer data can be outputted without increasing the noise such as light smearing or blur that may occur when the image sensor settings are changed, or without using a high specification image sensor.

The first processing unit may receive a first Bayer data from the image sensor through a mobile industry processor interface (MIPI). The first Bayer data that has been received is inputted into a first convolutional neural network, and the convolutional neural network outputs a second Bayer data having a second resolution from the first Bayer data having a first resolution.

A first convolutional neural network being learned by training to output a second Bayer data having a second resolution from first Bayer data having a first resolution outputs a second Bayer data having a second resolution by receiving a first Bayer data having a first resolution.

The convolutional neural network may be a model of at least one among a fully convolutional network (FCN), U-Net, MobileNet, residual dense network (RDN), and residual channel attention network (RCAN). It is natural that various other models can be utilized other than those.

A second Bayer data having the second resolution may be outputted to the ISP. As previously described, by performing resolution conversion using Bayer data before demosaic (RGB conversion) of the ISP, a second Bayer data having a second resolution is generated from the first Bayer data having a first resolution and outputted to the ISP. The ISP may generate an RGB image by performing RGB conversion on the second Bayer data having the second resolution.

To this end, the processor for generating second Bayer data having a second resolution from first Bayer data having a first resolution using the first convolutional neural network or the first convolutional neural network may be implemented as an ISP front end (software logic of the AP, that is, preprocessing logic of the ISP front end), implemented as a separate chip, or implemented inside a camera module. By receiving a Bayer data (image), a high resolution Bayer data (image) based on the Bayer data can be outputted. Bayer data, which is raw data, has a bit resolution of 10 bits or more, whereas if it undergoes the image processing process of the ISP, due to the data loss such as noise/artifact reduction and compression occurred in the ISP, and RGB data is 8 bits, and the information it contains is considerably reduced. In addition, ISP includes non-linear processing such as tone mapping, making it difficult to process image restoration, but Bayer data has linearity proportional to light so that image restoration can be easily handled. In addition, when using the same algorithm as compared to using RGB data that uses a Bayer data, the signal-to-noise ratio (PSNR) is also increased by about 2 to 4 dB, and through this, multi-frame de-noise or SR and the like being performed in the AP can be effectively processed.

That is, by using a Bayer data, the performance of the high resolution conversion may be enhanced, and since a Bayer data is outputted, additional image processing performance of the AP may also be enhanced.

The first convolutional neural network may be learned (trained) to output a second Bayer data having a second resolution based on a first Bayer data in order to generate a second Bayer data of high resolution. The training set for training the first convolutional neural network may be configured to be composed of a first Bayer data having a first resolution and a second Bayer data having a second resolution.

The first convolutional neural network is trained so that the Bayer data being outputted by increasing the resolution from first Bayer data having a first resolution constituting the training set to be the same as a second Bayer data constituting the training set. The process of training the first convolutional neural network will be described in detail later.

The second processing unit of the image processing device according to an embodiment of the present invention may include a second convolutional neural network that outputs a second Bayer data having a fourth resolution from second IR data having a third resolution. The second processing unit may include a pipelined processor and a convolutional neural network that has been learned to generate a second IR data from first IR data. The second processing unit may output the second IR data from the first IR data using a second parameter derived through training for IR data processing. Here, the second parameter may be referred to as a second deep learning parameter.

The second convolutional neural network according to an embodiment of the present invention is being learned to generate second IR data having a fourth resolution from the first IR data having a third resolution.

The second convolutional neural network that has been learned may receive a first IR data and generate a second IR data. Here, the first IR data may be an IR data having a third resolution, and the second IR data may be an IR data having a fourth resolution. Here, the third resolution may have a resolution different from the fourth resolution, and the fourth resolution may be a higher resolution than the third resolution.

By generating the second IR data using a second convolutional neural network that has been learned, a second IR data having a fourth resolution can be outputted without changing the settings of the image sensor such as the zoom magnification, the aperture, and the shutter speed, or using a ToF sensor having a high resolution. A high resolution IR data can be outputted without using a high specification image sensor or without increasing the noise that may occur when the setting of the ToF sensor is changed.

The first processing unit may receive a first IR data from the image sensor through a mobile industry processor interface (MIPI). The received first IR data is inputted to a second convolutional neural network, and the second convolutional neural network outputs a second IR data having a fourth resolution from first IR data having a third resolution.

A second convolutional neural network being learned by training to output a second IR data having a fourth resolution from first IR data having a third resolution outputs a second IR data having a fourth resolution by receiving a first IR data having a third resolution.

The convolutional neural network may be a model of at least one among a fully convolutional network (FCN), U-Net, MobileNet, residual dense network (RDN), and residual channel attention network (RCAN). It is natural that various other models can be utilized other than those.

The second IR data having a fourth resolution may be outputted to the ISP. As described above, by performing resolution conversion using the IR data before the ISP operation, a second IR data having a fourth resolution is generated from the first IR data having a third resolution and outputted to the ISP. The ISP may generate an IR image from second IR data having a fourth resolution.

To this end, the processor for generating second Bayer data having a fourth resolution from first IR data having a third resolution using the second convolutional neural network or the second convolutional neural network may be implemented as an ISP front end (software logic of the AP, that is, preprocessing logic of the ISP front end), implemented as a separate chip, or implemented inside a camera module. By receiving an IR data (image), a high resolution IR data (image) based on the IR data can be outputted.

That is, by using an IR data, the performance of high resolution conversion may be enhanced, and since the IR data is outputted, the additional image processing performance of the AP may also be enhanced.

The second convolutional neural network may be learned (trained) to output a second IR data having a fourth resolution based on a first IR data in order to generate a second IR data of high resolution. The training set for training the second convolutional neural network may configured to be composed of a first IR data having a third resolution and a second IR data having a fourth resolution.

The second convolutional neural network is trained so that the IR data being outputted by increasing the resolution from first IR data having a third resolution constituting a training set is to be identical to the second IR data constituting the training set. The process of training the second convolutional neural network will be described in detail later.

The image sensor 110 may include an image sensor such as a complementary metal oxide semiconductor (CMOS) or a charge coupled device (CCD) that converts light entering through a lens of the camera module into an electrical signal. The image sensor 110 may generate a Bayer data including information on a Bayer pattern by using the acquired image through a color filter. The Bayer data may have a first resolution according to a specification of the image sensor 110 or a zoom magnification set when a corresponding image is generated.

A first Bayer data having a first resolution generated and outputted by the image sensor 110 is inputted to the first processing unit 131. The first processing unit 131 may perform deep learning to generate a second Bayer data from first Bayer data. The second Bayer data may be generated from the first Bayer data by using an algorithm that increases the resolution other than deep learning. It is natural that various algorithms used for super resolution (SR) can be used. A process in which the first processing unit 131 generates the second Bayer data from the first Bayer data by using deep learning may be performed as follows.

The first processing unit 131 includes a deep learning network 131-1 that generates Bayer data having a second resolution from first Bayer data having a first resolution as shown in FIG. 2, and may store a Bayer parameter 131-2 which is a first deep learning parameter used to generate a Bayer data having a second resolution from first Bayer data having a first resolution. The first deep learning parameter 131-2 may be stored on a memory. The first processing unit 131 may be implemented in the form of a chip to generate a second Bayer data from first Bayer data.

The first processing unit 131 may include one or more processors, and at least one program command executed through the processor may be stored in one or more memories. The memory may include a volatile memory such as SRAM or DRAM. However, it is not limited thereto, and in some cases, the memory 115 may include a non-volatile memory such as a flash memory, a read only memory (ROM), an erasable programmable read only memory (EPROM), and an electrically erasable programmable read only memory (EEPROM).

A typical camera device or camera module receives a Bayer pattern from an image sensor and outputs data in the form of an image through a process of applying a color (color interpolation process, color interpolation or demosaic), and information including Bayer pattern information may be extracted from the image, and data including the extracted information may be transmitted to the outside. Here, the Bayer pattern may include raw data being outputted by an image sensor that converts an optical signal included in a camera device or a camera module into an electrical signal.

To explain this in detail, the optical signal transmitted through the lens included in the camera module may be converted into an electrical signal through each pixel disposed in the image sensor capable of detecting colors of R, G, and B. For example, if the specification of the camera module is 5 million pixels, it can be considered that an image sensor including 5 million pixels capable of detecting colors of R, G, and B is included. Although the number of pixels of the image sensor is 5 million, it can be seen that each pixel does not actually detect all colors, but monochrome pixels that detect only the brightness of black and white are combined with any one of R, G, and B filters. That is, in the image sensor, R, G, and B color filters are disposed in a specific pattern on monochromatic pixel cells arranged as many as the number of pixels. Accordingly, the R, G, and B color patterns are disposed intersected with one another according to the user's (i.e., human) visual characteristics, and this is called a Bayer pattern. In general, the Bayer pattern has a smaller amount of data than image data. Therefore, there is an advantage in that even if the device is equipped with a camera module that does not have a high end processor, it can transmit and receive Bayer pattern image information relatively faster than image data, and based on this, the Bayer pattern image can be converted into images with various resolutions.

For example, since a camera module is mounted on a vehicle, the camera module does not require many processors to process images even in an environment where the low voltage differential signaling (LVDS) having a full-duplex transmission speed of 100 Mbit/s is used, and thus it is not overloaded so that it may not endanger the driver or the safety of the driver using the vehicle. In addition, since the size of data transmitted by the in-vehicle communication network can be reduced, there is an effect in that even if it is applied to an autonomous vehicle, it is possible to eliminate problems caused by the communication method, communication speed, and the like according to the operation of a plurality of cameras disposed in the vehicle.

In addition, when transmitting Bayer data of the Bayer pattern to the first processing unit 131, the image sensor may transmit data after down-sampling the Bayer pattern frame to a size of 1/n. After performing smoothing through a Gaussian filter or the like on the received Bayer pattern data before downsampling, downsampling may be performed. Thereafter, after generating frame packet based on the down-sampled image data, the completed frame packet may be transmitted to the first processing unit 131. However, this function may be performed by the first processing unit 131 instead of the image sensor.

In addition, the image sensor may include a serializer (not shown) that converts the Bayer pattern into serial data in order to transmit Bayer data using a serial communication method such as a low voltage differential signaling (LVDS). The serializer typically includes or may be implemented with a buffer that temporarily stores data and a phase-locked loop (PLL) that forms a period of data to be transmitted.

The deep learning algorithm (model) applied to the first processing unit 131 is an algorithm that generates image data having a higher resolution than that of the input image data, and it may refer to an optimal algorithm generated by repeatedly performing learning through deep learning training.

Deep learning, also referred to as deep structured learning, refers to a set of algorithms related to machine learning that attempts high level abstraction (a task that summarizes core contents or functions in large amounts of data or complex data) through a combination of several nonlinear transformation methods.

Specifically, deep learning expresses any learning data in a form that a computer can understand (for example, in the case of an image, pixel information is expressed as a column vector, and the like), and is a learning technique for a lot of research (how to make a better representation technique and how to make a model to learn these) to apply these to learning, and may include learning techniques such as deep neural networks (DNN) and deep belief networks (DBN).

The first processing unit 131 generates second Bayer data from first Bayer data by performing deep learning. The deep learning model of FIG. 3 may be used as an example of a method of performing deep learning from first Bayer data having a first resolution to generate a second Bayer data having a second resolution.

The deep learning model in FIG. 3 is a deep learning model to which a deep neural network (DNN) algorithm is applied, and is a diagram illustrating a process of generating data having a new resolution as the DNN algorithm is applied.

Deep neural networks (DNNs) may be specified as a deep neural network in which multiple hidden layers exist between an input layer and an output layer, a convolutional neural network that forms a pattern of connections between neurons, similar to the structure of the visual cortex of animals, and a recurrent neural network that builds up a neural network at every moment over time.

Specifically, DNN classifies neural networks by repeating convolution and sub-sampling to reduce and distort the amount of data. That is, DNN outputs classification results through feature extraction and classification actions, and is mainly used to analyze images; and convolution means image filtering.

Referring to FIG. 3 to describe a process in which the first processing unit 131 to which the DNN algorithm is applied performs deep learning, the first processing unit 131 performs convolution and sub-sampling on the region to increase the magnification based on the Bayer data 10 of the first resolution.

Increasing the magnification means enlarging only a specific part of the first Bayer data. Accordingly, since the portion not selected by the user is a portion that the user is not interested in, there is no need to perform a process of increasing the resolution, so that only the portion selected by the user may be subjected to the convolution and sub-sampling process. Through this, by not performing unnecessary calculations, the amount of calculations can be reduced and processing speed can be increased.

Sub-sampling refers to a process of reducing the size of an image. As an example, sub-sampling may use a Max-pool method and the like. Max-pull is a technique that selects the maximum value in a given region, similar to how neurons respond to the largest signal. Sub-sampling has advantages of reducing noise and increasing learning speed.

When convolution and sub-sampling are performed, a plurality of image data may be outputted as illustrated in FIG. 3. Here, the plurality of image data 20 may be a feature map. Thereafter, a plurality of image data having different features may be outputted using an upscale method based on the outputted image data. The upscaling method means scaling an image by r*r times using r\hat{ }2 different filters.

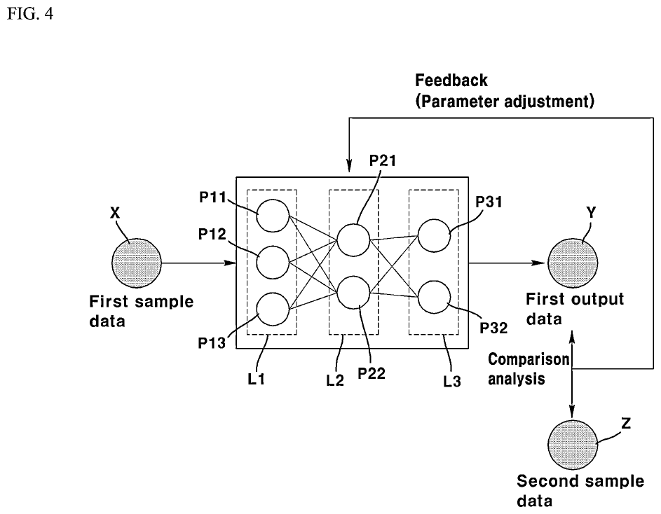

When a plurality of image data is outputted as illustrated in FIG. 4 according to the upscale 30, the first processing unit 131 may finally output the second Bayer data 40 having a second resolution by recombining the image data based on the image data.

A first deep learning parameters used by the first processing unit 131 to generate a second Bayer data from first Bayer data by performing deep learning may be derived through deep learning training.

Deep learning can be divided into training and inference. Training refers to the process of learning a deep learning model through input data, and inference refers to the process of performing image processing with the deep learning model that has been learned. That is, the image is processed using the deep learning model to which the parameters of the deep learning model derived through training are applied.

In order to perform deep learning to generate a second Bayer data from first Bayer data, a first deep learning parameter required for Bayer data processing must be derived through training. When the first deep learning parameter is derived through training, the inference for generating second Bayer data from first Bayer data may be performed by performing deep learning using the deep learning model to which the corresponding Bayer parameter is applied. Therefore, a training process for deriving parameters for performing deep learning should be performed.

The deep learning training process may be performed through repetitive learning as shown in FIG. 4. After receiving the first sample data X and the second sample data Z having different resolutions, deep learning training may be performed based on this.

Specifically, based on the parameters generated by comparing and analyzing the first output data Y and the second sample data Z that have been subjected to deep learning training using the first sample data X as input data, a higher resolution algorithm that generate Bayer data can be generated.

Here, the output data Y is data outputted through actual deep learning, and the second sample data Z is data inputted by the user and may mean data that can be most ideally outputted when the first sample data X is inputted to the algorithm. Here, the first sample data X may be data whose resolution is lowered by down-sampling the second sample data Z. At this time, the down-sampling degree may vary according to a zoom ratio to be enlarged through deep learning, that is, a zoom ratio to perform digital zoom. For example, if the zoom ratio to be performed through deep learning is 3 times and the resolution of the second sample data Z is 9 MP (mega pixel), the resolution of the first sampling data X must be 1 MP, when deep learning is performed, so that the resolution of the first output data Y, whose resolution is increased three times, becomes 9 MP, and thus the first sample data Y of 1 MP may be generated by down-sampling the second sample data Z of 9 MP by 1/9.

The difference between the two data is calculated by comparing and analyzing the first output data Y and the second sample data Z being outputted through deep learning according to the input of the first sample data X, and feedback can be given to the parameters of the deep learning model in the direction of reducing the difference between the two data. At this time, the difference between the two data may be calculated through a mean squared error (MSE) method, which is one of the loss functions. In addition, various loss functions such as cross entropy error (CEE) and the like can be used.

Specifically, after analyzing the parameters affecting the output data, feedback is given by changing, deleting, or generating new parameters, so that there may be no difference between the second sample data Z and the first output data Y, which is the actual output data.

As illustrated in FIG. 4, it may be assumed that there are a total of 3 layers L1, L2, and L3 that affect the algorithm, and there are a total of 8 parameters P11, P12, P13, P21, P22, P31, and P32 in each layer. In this case, if the difference between the first output data Y and the second sample data Z increases when the parameter is changed in the direction of increasing the value of the parameter P22, the feedback can change the algorithm in the direction of decreasing the parameter P22. Conversely, if the difference between the first output data Y and the second sample data Z decreases when the parameter is changed in the direction of increasing the value of the parameter P33, the feedback can change the algorithm in the direction of increasing the P33 parameter.

That is, the algorithm to which deep learning is applied through this method may derive parameters so that the first output data Y is outputted similarly to the second sample data Z. At this time, the resolution of the second sample data Z may be the same as or higher than the resolution of the first output data Y, and the resolution of the second sample data Z may be the same as the resolution of the first output data Y.

In deep learning training, as shown in FIG. 4, when an output result and a comparison target exist, and learning is performed through comparison with the comparison target, training can also be performed using a reward value. In this case, it is possible to first recognize the surrounding environment and transmit the current environment state to a processor that performs deep learning training. The processor performs an action corresponding to it, and the environment informs the processor of the reward value according to the action again. And the processor takes the action that maximizes the reward value. Training can be performed by repeatedly performing learning through this process. In addition, deep learning training can be performed using various deep learning training methods.

In general, in order to implement a processor capable of deep learning with a small chip, the number of deep learning processes and memory gates should be minimized, and in here, the factors that have the greatest influence on the number of gates are the algorithm complexity and the amount of data processed per clock, and the amount of data processed by the processor varies depending on the input resolution.

Therefore, since the processor 220 according to an embodiment generates an image with a high magnification by reducing the input resolution to reduce the number of gates and then upscaling it later, there is an advantage in that the image can be generated more quickly.

For example, if an image with an input resolution of 8 MP (mega pixel) needs 2×zoom, the horizontal and vertical upscaling is performed twice by 2 times based on the ¼ area (2 MP). And after ¼ downscaling of the ¼ area (2 MP) and using an image with a resolution of 0.5 MP as input data for deep learning, and if the 4× zoom is performed, based on the generated image, by upscaling horizontally and vertically by 4 times each, a zoom image of the same area as the 2× zoom can be generated.

Therefore, since deep learning generates an image by learning as much as a magnification corresponding to the loss of resolution in order to prevent performance degradation due to loss of input resolution, there is an advantage in that performance degradation can be minimized.

In addition, deep learning-based algorithms for realizing high resolution images generally use a frame buffer, which may be difficult to run in real time in general PCs and servers due to its characteristics.

However, since the first processing unit 131 according to an embodiment of the present invention applies an algorithm already generated through deep learning, it can be easily applied to a low-spec camera module and various devices including the same. Since high resolution is implemented in a way that uses only a few line buffers, so there is also an effect that a processor can be implemented with a relatively small chip.

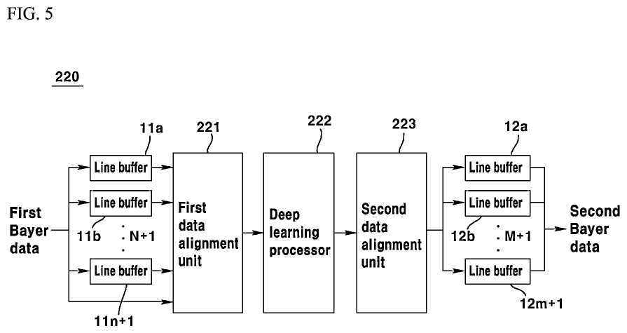

At least one line buffer that stores the first Bayer data line by line is included and when a first Bayer data of a predetermined number of lines is stored in the line buffer, the first processing unit 131 may perform to generate a second Bayer data for the first Bayer data stored in the line buffer. The first processing unit 131 divides and receives the first Bayer data for each line, and stores the first Bayer data received for each line in a line buffer. After receiving the first Bayer data of all lines, the first processing unit 131 does not generate the second Bayer data, and when the first Bayer data of a predetermined number of lines is stored, then may perform to generate second Bayer data for the first Bayer data stored in the line buffer. If you want to increase the resolution 9 times, which is equivalent to 3× zoom, and when the first Bayer data of 3 lines is stored in the line buffer, second Bayer data for the first Bayer data of the stored three lines is generated. A detailed configuration in which the line buffer is formed will be described with reference to FIG. 5.

Referring to FIG. 5, the first processing unit 131 may comprise: a plurality of line buffers 11 for receiving the first Bayer data; a first data alignment unit 221 for generating first array data for arranging the first Bayer data outputted through the line buffer for each wavelength band; a deep learning processor 222 that performs deep learning; a second data alignment unit 223 for generating second Bayer data by arranging the second array data outputted through the deep learning processor 222 in a Bayer pattern; and a plurality of line buffers 12 for outputting the second Bayer data outputted through the second data alignment unit 223.

The first Bayer data is information including the Bayer pattern described previously, and although described as Bayer data in FIG. 5, it may be defined as a Bayer image or a Bayer pattern.

In addition, in FIG. 5, the first data alignment unit 221 and the second data alignment unit 223 are illustrated as separate components for convenience, but are not limited thereto, and the deep learning processor 222 may perform functions performed by the first data alignment unit 221 and the second data alignment unit 223, which will be described later.

Referring to FIG. 5, the first Bayer data of the first resolution may transmit image information on an area selected by the user to n+1 line buffers 11a, 11b, . . . , 11n, and 11n+1. As described previously, since the Bayer image having the second resolution is generated only for the area selected by the user, image information on the area not selected by the user is not transmitted to the line buffer 11.

Specifically, the first Bayer data includes a plurality of row data, and the plurality of row data may be transmitted to the first data alignment unit 221 through the plurality of line buffers 11.

For example, if the area in which deep learning is to be performed by the deep learning processor 222 is a 3×3 area, a total of three lines must be simultaneously transmitted to the first data alignment unit 221 or the deep learning processor 222 to perform deep learning. Accordingly, information on the first line among the three lines is transmitted to the first line buffer 11a and then stored in the first line buffer 11a, and information on the second line among the three lines is transmitted to the second line buffer 11b and then may be stored in the second line buffer 11b.

After that, in the case of the third line, since there is no information on the line received thereafter, it may not be stored in the line buffer 11 and may be directly transmitted to the deep learning processor 222 or the first data alignment unit 221.

At this time, since the first data alignment unit 221 or the deep learning processor 222 must simultaneously receive information on three lines, the information on the first line and the information on the second line stored in the first line buffer 11a and the second line buffer 11b may be simultaneously transferred to the deep learning processor 222 or the first image alignment unit 219.

On the contrary, if the area where deep learning is to be performed by the deep learning processor 222 is an (N+1)×(N+1) area, only when a total of N+1 lines is simultaneously transmitted to the first data alignment unit 221 or to the deep learning processor 222 to perform deep learning. Accordingly, information on the first line among N+1 lines is transmitted to the first line buffer 11a and then stored in the first line buffer 11a, information on the second line among N+1 lines may be transmitted to the second line buffer 11b and then stored in the second line buffer 11b, and information on the Nth line among N+1 lines may be transmitted to the Nth line buffer 11n and then stored in the Nth line buffer 11n.

After that, in the case of the (N+1)th line, since there is no information about the line being received thereafter, it is not stored in the line buffer 11 and may be directly transmitted to the deep learning processor 222 or the first data alignment unit 221, and as described previously, at this time, since the first data alignment unit 221 or the deep learning processor 222 must simultaneously receive information on N+1 lines, information on the first to nth lines stored in the line buffers 11a to 11n may also be simultaneously transmitted to the deep learning processor 222 or the first image alignment unit 219.

After receiving Bayer data from the line buffer 11, the first image alignment unit 219 generates first array data by arranging Bayer data for each wavelength band, and then may transmits the generated first array data to the deep learning processor 222.

The first image alignment unit 219 may generate first array data arranged by classifying the received information into specific wavelengths or specific colors (red, green, and blue).

Thereafter, the deep learning processor 222 may generate second array data by performing deep learning based on the first array data received through the first image alignment unit 219.

Accordingly, the deep learning processor 222 may perform deep learning based on the first array data received through the first image alignment unit 219 so that second array data of a second resolution higher than the first resolution may be generated.

For example, as described previously, when first array data is received for a 3×3 area, deep learning is performed for the 3×3 area, and when first array data is received for the (n+1)×(n+1) area, deep learning may be performed for the (n+1)×(n+1) area.

Thereafter, the second array data generated by the deep learning processor 222 is transmitted to the second data alignment unit 223, and the second data alignment unit 223 may convert the second array data into second Bayer data having a Bayer pattern.

Thereafter, the converted second Bayer data is outputted to the outside through the plurality of line buffers 12a, and the outputted second Bayer data may be generated as Bayer data having a second resolution that is higher than the first resolution by yet another process.

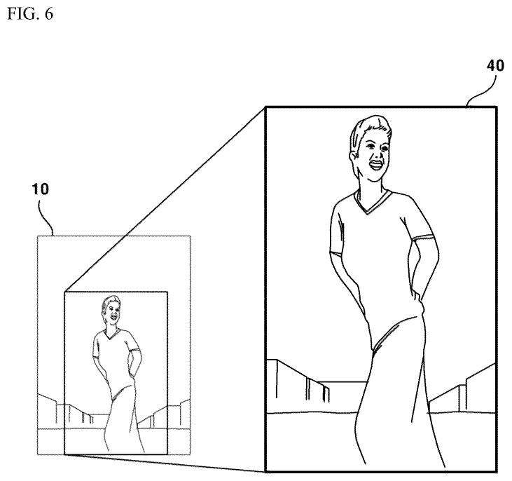

FIG. 6 is a diagram illustrating images in which an image of first Bayer data of a first resolution is converted into second Bayer data of a second resolution by the first processing unit 131.

When the user selects a specific area in the Bayer data 10 having a first resolution, the first processing unit 131 performs deep learning to convert the resolution and, and as a result, as illustrated in FIG. 6, the Bayer data 40 having a second resolution may be generated.

The second processing unit 132 may perform deep learning to generate a second IR data from first IR data. As previously described, the first IR data is an IR data having a third resolution, and the second IR data is an IR data having a fourth resolution. The fourth resolution may be a resolution different from the third resolution, and the fourth resolution may be higher than the third resolution. The IR data is data generated and outputted by the ToF sensor 120, and generally has a lower resolution than a Bayer data generated and outputted by the image sensor 110. In order to improve the quality of an RGB image generated from the Bayer data using an IR data, it is necessary to increase the resolution of the IR data, so the second processing unit 132 converts the first IR data to a second IR data having a high resolution. As such, the second IR data that has been generated is used to generate an IR image.

The ToF sensor 120 is one among the devices capable of acquiring depth information. According to the ToF method, the ToF sensor 120 calculates the distance to the object by measuring the time of flight, that is, the time when light is emitted and reflected. The ToF sensor 120 and the image sensor 110 may be disposed inside of one device, for example, one optical device, or implemented as separate devices to photograph the same area. The ToF sensor 120 generates an output light signal and then irradiates an object.

The ToF sensor 120 may use at least one of a direct method and an indirect method. In the case of the indirect method, an output light signal may be generated and outputted in the form of a pulse wave or a continuous wave. The continuous wave may be in the form of a sinusoid wave or a square wave. By generating the output light signal in the form of a pulse wave or a continuous wave, the ToF sensor 120 may detect a phase difference between the output light signal and the input light signal inputted to the ToF sensor 120 after being reflected from the object.

The direct method is a method of inferring the distance by measuring the time the output light signal sent toward the object returns to the receiver, and the indirect method is a method of indirectly measuring the distance using the phase difference when the sine wave sent toward the object returns to the receiver. It takes advantage of the difference between the peaks (maximum) or valleys (minimum) of two waveforms having the same frequency. The indirect method requires light with a large pulse width to increase the measuring distance, and there are characteristics in which as the measurement distance increases, the precision decreases, and conversely, as the precision increases, the measurement distance decreases. The direct method is more advantageous for long distance measurement than the indirect method.

The ToF sensor 120 generates an electrical signal from an input light signal. The phase difference between the output light and the input light is calculated using the generated electrical signal, and the distance between the object and the ToF sensor 120 is calculated using the phase difference. Specifically, the phase difference between the output light and the input light may be calculated using the information of the charge amount of the electrical signal. Four electrical signals may be generated for each frequency of the output light signal. Accordingly, the ToF sensor 120 may calculate the phase difference t_{d} between the output light signal and the input light signal using Equation 1 below.

$${t}_{d} = arctan ( \frac{{Q}_{3} - {Q}_{4}}{{Q}_{1} - {Q}_{2}} ) \qquad [ Equation 1 ]$$

Here, Q₁ to Q₄ are the charge amounts of each of the four electrical signals. Q₁ is the electric charge amount of the electric signal corresponding to the reference signal of the same phase as the output light signal. Q₂ is the electric charge amount of the electrical signal corresponding to the reference signal 180 degrees slower in phase than the output optical signal. Q₃ is the electric charge amount of the electrical signal corresponding to the reference signal 90 degrees slower in phase than the output optical signal. Q₄ is the electric charge amount of the electrical signal corresponding to the reference signal 270 degrees slower in phase than the output light signal. Then, the distance between the object and the ToF sensor 120 may be calculated using the phase difference between the output light signal and the input light signal.

At this time, the distance d between the object and the ToF sensor 120 may be calculated using Equation 2 below.

$$d = \frac{c}{2 f} \frac{{t}_{d}}{2 π} \qquad [ Equation 2 ]$$

Here, c is the speed of light and f is the frequency of the output light.

The ToF sensor 120 generates an IR data using an output light and an input light. At this time, the ToF sensor 120 may generate raw data that is IR data for four phases. Here, the four phases may be 0°, 90°, 180°, and 270°, and the IR data for each phase may be data composed of digitized pixel values for each phase. IR data may be interchangeably used with phase data (image), phase IR data (image), and the like.

The second processing unit 132 generates second IR data having a fourth resolution from first IR data having a third resolution generated and outputted from the ToF sensor 120. The second processing unit 132, as shown in FIG. 2, may store: a deep learning network 132-1 that generates second an IR data from first IR data; and an IR data parameter 132-2, which is a second deep learning parameter used to generate a second IR data having a fourth resolution from first IR data having a third resolution. The second deep learning parameter 132-2 may have been stored in a memory, and the second processing unit 132 may be implemented in the form of a chip (chip2) to generate a second IR data from first IR data.

The deep learning network 132-1 of the second processing unit 132 may have the same structure as the deep learning network 131-1 of the first processing unit 131. When deep learning is performed using Bayer data, it may consist of 4 channels. When the ToF sensor uses the indirect method, the 4 first IR data is inputted, so the deep learning network of 4 channels can be used as it is, and even when the ToF sensor uses the direct method, a deep learning network of 4 channels can be used as it is by dividing one of the first IR data into 4 and inputting it. Or, the deep learning network 132-1 of the second processing unit 132 may be formed in a different structure from the deep learning network 131-1 of the first processing unit 131.

The deep learning algorithm (model) applied to the second processing unit 132 may be an algorithm for generating image data having a higher resolution than that of the input image data. The deep learning model applied to the second processing unit 132 may correspond to the deep learning model applied to the first processing unit 131 described above. Or, various deep learning models for generating second IR data having a fourth resolution from first IR data having a third resolution may be used.

When the deep learning model applied to the second processing unit 132 is a deep learning model corresponding to the deep learning model applied to the first processing unit 131, a second deep learning parameter used to generate a second IR data having a fourth resolution from first IR data having a third resolution can be derived through separate deep learning training. Since the detailed description of the deep learning model applied to the second processing unit 132 corresponds to the deep learning model applied to the first processing unit 131 described with reference to FIGS. 3 and 4, the following overlapping descriptions will be omitted.

The second processing unit 132 generates a second IR data having a fourth resolution from first IR data having a third resolution by performing deep learning using an IR data parameter derived through deep learning training.

In addition, at least one line buffer that stores the first Bayer data line by line is included and when a first Bayer data of a predetermined number of lines is stored in the line buffer, the second processing unit 132 may perform to generate a second IR data for the first IR data stored in the line buffer. The description of the line buffer of the second processing unit 132 corresponds to the description of the line buffer of the first processing unit 131, and thus the overlapping description will be omitted.

The image processing unit 133 may generate a first RGB image from the second Bayer data by receiving a second Bayer data generated by performing deep learning in the first processing unit 131 and a second IR data generated by performing deep learning in the second processing unit 132, and may generate an IR image from the second IR data.

The second Bayer data generates a first RGB image 133-1, as shown in FIG. 2, through image processing in the image processing unit 133, and the second IR data is used in the image processing unit 133 to generate an IR image 133-2 and a depth image 133-3. The generated IR image is used to generate a second RGB image 133-1 with improved image quality from the first RGB image. Finally, a high resolution RGB image with improved brightness, a high resolution IR image, and a high resolution depth image may be outputted through the image processing of the image processing unit 133.

The image processing unit 133 may generate a first RGB image through image processing on a second Bayer data. The image processing process for the second Bayer data of the image processing unit 133 may include more than one among gamma correction, color correction, auto exposure correction, and auto white balance correction processes. The image processing unit 133 may be an image signal processor (ISP), and may be formed on the AP. Or, it may be a processing unit configured separately from the ISP.

In addition, the image processing unit 133 may generate an IR data that is an amplitude image or an intensity image by using the IR data.

When the ToF sensor 120 is an indirect method, when calculated as in Equation 3 using four IR data having four different phases being outputted from the ToF sensor 120, an amplitude image which is a ToF IR image can be obtained.

$$Amplitude Amplitude = \frac{1}{2} \sqrt{{( Raw ( {x}_{90} ) - Raw ( {x}_{270} ) )}^{2} + {( Raw ( {x}_{180} ) - Raw ( {x}_{0} ) )}^{2}} \qquad [ Equation 3 ]$$

Here, Raw(x₀) is the data value for each pixel received by the ToF sensor at phase 0°, Raw(x₉₀) is the data value for each pixel received by the sensor at phase 90°, Raw(x₁₈₀) is the data value for each pixel received by the sensor at phase 180°, and Raw(x₂₇₀) may be a data value for each pixel received by the sensor at phase 270°.

Or, an intensity image, which is another ToF IR image, may be obtained by performing an operation as in Equation 4 using four IR data.

Intensity=|Raw(x₀₀)−Raw(x₂₇₀)|+|Raw(x₁₈₀)−Raw(x₀)| [Equation 4]

As described above, the ToF IR image is an image generated through a process of subtracting two of four phase IR data from each other, and in this process, external light (background light) may be removed. Accordingly, only the signal of the wavelength band outputted by the light source remains in the ToF IR image, thereby increasing the IR sensitivity of the object and remarkably reducing noise.

The IR image generated by the image processing unit 133 may mean an amplitude image or an intensity image, and the intensity image may be interchangeably used with a confidence image. The IR image may be a gray image.

Meanwhile, when the four-phase IR data is used to calculate as in Equations 5 and 6, a depth image can also be obtained.

$$Phase = arctan ( \frac{Raw ( {x}_{90} ) - Raw ( {x}_{270} )}{Raw ( {x}_{180} ) - Raw ( {x}_{0} )} ) \qquad [ Equation 5 ]$$

$$Phase = arctan ( \frac{Raw ( {x}_{90} ) - Raw ( {x}_{270} )}{Raw ( {x}_{180} ) - Raw ( {x}_{0} )} ) \qquad [ Equation 6 ]$$

The image processing unit 133 generates a second RGB image with improved image quality from the first RGB image by using the generated IR image.

More specifically, the image processing unit 133 may generate the second RGB image by using the result value calculated by calculating the reflection component of the first RGB image and the IR image, and the hue component and chroma component of the first RGB image.

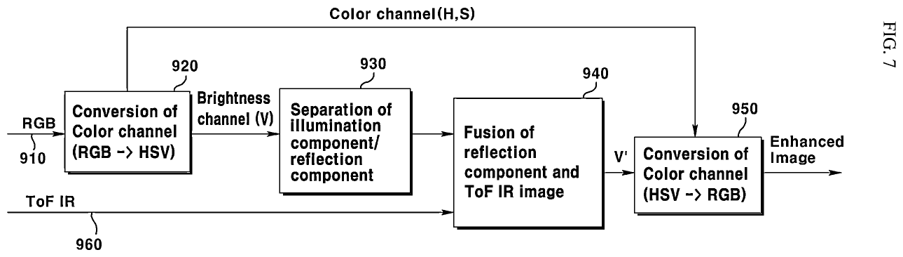

By using the IR image generated as described above, it is possible to improve the quality of the RGB image generated by being photographed by the image sensor 110 in a low luminance environment. Referring to FIG. 7, the image processing unit 133 generates (910) a first RGB image from second Bayer data having a second resolution generated by the first processing unit 131. Thereafter, the first RGB image is converted into the first HSV image through color channel conversion (920). Here, the RGB image means data represented by a combination of three components of red, green, and blue, and the HSV image may mean data expressed as a combination of three components: hue, saturation, and value. Here, hue and saturation may have color information, and value may have brightness information. Then, the brightness component (V) among the hue component (H), chroma component (S), and lightness component (V) of the first HSV image is separated into a reflection component and an illumination component, thereby extracting the reflection component (930).

Here, the reflection component may include a high frequency component, the illumination component may include a low frequency component, and hereinafter, although it is explained as an example that in order to extract the reflection component, the brightness component (V) is separated into a low frequency component and a high frequency component, and then the high frequency component is separated therefrom, but is not limited thereto. A reflection component, for example, a high frequency component, may include gradient information or edge information of an image, and an illumination component, for example, a low frequency component, may include brightness information of the image.

To this end, the low frequency component (L) may be obtained by performing low pass filtering on the brightness component (V) of the first HSV image. If low pass filtering is performed on the brightness component (V) of the first HSV image, it may be blurred and thus gradient information or edge information may be lost. A high frequency component (R) of the brightness component of the first HSV image is obtained through an operation of removing the low frequency component (L). To this end, the brightness component (V) and the low frequency component (L) of the first HSV image may be calculated. For example, an operation of subtracting the low frequency component (L) from the brightness component (V) of the first HSV image may be performed.

The image processing unit 133 generates (960) an IR image from the second IR data generated by the second processing unit 132. Here, the ToF IR image may be an amplitude image or an intensity image generated from the IR data for four phases of 0°, 90°, 180° and 270°.

At this time, the image processing unit 133 may correct the IR image before performing a calculation with the first RGB image. As shown in FIG. 8, the ToF IR image may be subjected to a preprocessing (970) for performing correction prior to calculation. For example, the ToF IR image may have a different size from the first RGB image, and in general, the ToF IR image may be smaller than the first RGB image. Accordingly, by performing interpolation on the ToF IR image, the size of the ToF IR image may be enlarged to the size of the first RGB image (971). Since the image may be distorted during the interpolation process, the brightness of the ToF IR image may be corrected (972). Or, as described above, when generating the second IR data in the second processing unit 132, the second IR data may be generated to have a fourth resolution equal to the resolution of the first RGB image. When the second processing unit 132 generates the second IR data to have the same fourth resolution as the resolution of the first RGB image, size interpolation for the IR image may be omitted.

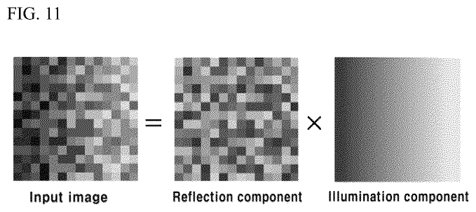

Referring back to FIG. 7, while obtaining the illumination component for the brightness component of the first HSV image, the reflection component for the brightness component of the first HSV image, for example, the high frequency component and the ToF IR image, is used to obtain the second HSV Obtain the brightness component (V′) of the image (930). Specifically, as shown in FIG. 10, a reflection component of the brightness component of the first HSV image, for example, a high frequency component and a ToF IR image may be matched (980). Here, a calculation for obtaining an image with improved brightness by merging the illumination component and the reflection component modeled using the ToF IR image may be used, and this may be a calculation opposite to the calculation used to remove the low frequency component L from the brightness component of the first HSV image. For example, an operation in which a reflection component, for example, a high frequency component, and a ToF IR image are added to the brightness component of the first HSV image may be performed (940). In this way, after removing the illumination component for the brightness component of the first HSV image, for example, the low frequency component, and when calculates the reflection component for the brightness component of the first HSV image, for example, the high frequency component and the ToF IR image, the brightness of RGB images photographed in a low luminance environment can be improved.

After that, a second RGB image is generated through color channel conversion (950) using the brightness component (V′), and the hue component (H) and chroma component (S) obtained through the color channel conversion (920). In the HSV image, the hue component (H) and the chroma component (S) may have color information, and the brightness component may have brightness information. When only the reflection component of the brightness component is used as calculated with the ToF IR image (V′) and the hue component (H) and chroma component (S) are used as previously obtained, only the brightness in a low luminance environment is improved without color distortion. As shown in FIG. 11, the input image may consist of a product of a reflection component and an illumination component; the reflection component may consist of a high frequency component; the illumination component may consist of a low frequency component; and the brightness of the image may be affected by the illumination component. However, when the illumination component, that is, the low frequency component, is removed from the RGB image photographed in a low luminance environment, the brightness value of the RGB image may become excessively high. In order to compensate for this, by matching the ToF IR image with the brightness component of the RGB image from which the illumination component, that is, the low frequency component, has been removed, as a result, an RGB image with improved image quality can be obtained in a low luminance environment.

As previously described, the IR image generated by the image processing unit 133 may be an amplitude image or intensity image generated from second IR data according to four different phases generated by the second processing unit 132, and in the case of an indirect ToF sensor using IR data according to four different phases, since one cycle time of the ToF sensor is required to generate one IR image, the time for generating the first IR data in the ToF sensor may be longer than the time for generating the Bayer data, and accordingly, a time delay may occur in generating an RGB image with improved image quality.

In order to prevent such a time delay, the frame rate per hour (fps) of the ToF sensor 120 may be faster than the frame rate per hour of the image sensor 110. In order for the ToF sensor 120 to generate one IR image, it is necessary to generate IR data according to four different phases, and to this end, it is possible to prevent a time delay by controlling the frame rate per hour of the ToF sensor 120 that photographs the sub-frame that is the IR data according to each phase to be faster than the frame rate per hour of the image sensor 110. The frame rate per hour of the ToF sensor 120 may be set according to the frame rate per hour of the image sensor 110. A speed at which the ToF sensor 120 captures a sub-frame that is IR data according to one phase may be faster than a speed at which the image sensor 110 photographs a single Bayer data to generate one Bayer data. In addition, the frame rate per hour may vary according to a work environment, zoom magnification, or specifications of the ToF sensor 120 or the image sensor 110. Therefore, in consideration of the time for which the ToF sensor 120 generates IR data according to four different phases to generate one IR image and the time taken for the image sensor 110 to generate one Bayer data, the frame rate per time of the ToF sensor 120 may be set differently. The frame rate per hour may be a shutter speed of each sensor.

In addition, the image processing unit 133 may generate a three-dimensional color image including both color information and depth information by matching and rendering the second RGB image as well as the IR image and depth image generated from the IR data of the ToF sensor 120 to the RGB image.

The first processing unit 131 or the second processing unit 132 may be formed in the form of an independent chip. Or, it may be formed in units of functional blocks of other chips. The first processing unit 131 or the second processing unit 132 may be formed on an image sensor module, a camera module, or an AP module.

Here, the application processor (AP) is a mobile memory chip and means a core semiconductor in charge of various application operations and graphic processing in the mobile terminal device. The AP can be implemented in the form of a system on chip (SoC) that includes both the functions of a computer's central processing unit (CPU) and the functions of a chipset that controls the connection of other devices such as memory, hard disk, and graphic card.

When the first processing unit 131 or the second processing unit 132 is formed in the image sensor module, the first processing unit 131 is formed in an RGB image sensor module, and the second processing unit 132 may be formed in a ToF sensor module. Or, the first processing unit 131 and the second processing unit 132 may be formed in one image sensor module.

When the first processing unit 131 or the second processing unit 132 is formed on the camera module or the AP module, the first processing unit 131 and the second processing unit 132 may be formed individually, or may be integrated into one module or chip. Or, it may be formed as one processing unit. Furthermore, the first processing unit 131 and the second processing unit 132 may be formed in various shapes and positions, such as being formed at different positions.

The first processing unit 131 or the second processing unit 132 has been described as performing a function of increasing the resolution, but like the driver IC of the camera module, it may be implemented to process functions processed by one or more processors of a device in which the image processing device 130 is formed such as camera devices, image processing devices, optical devices, and smart terminals. In this way, functions of existing processors can be integrated or replaced.

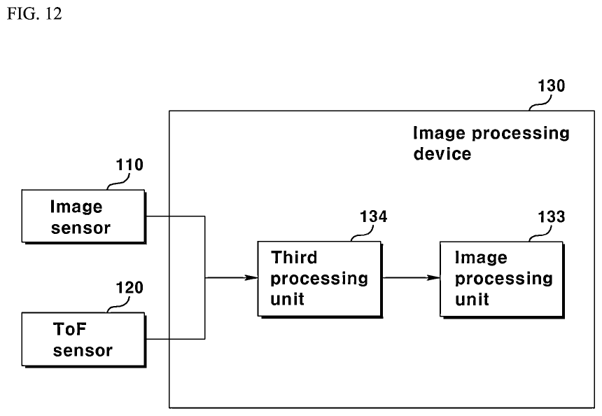

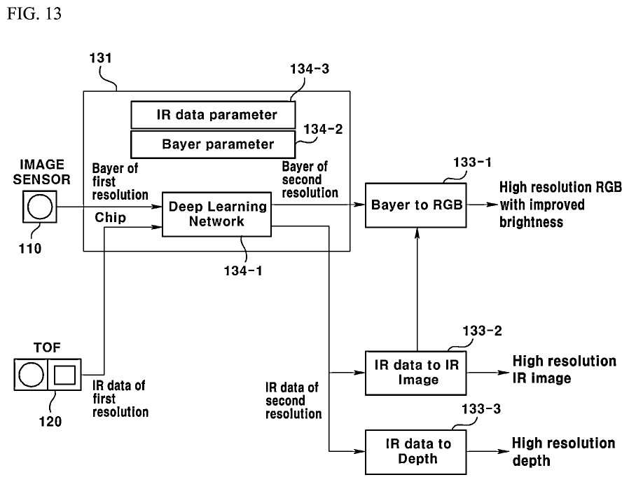

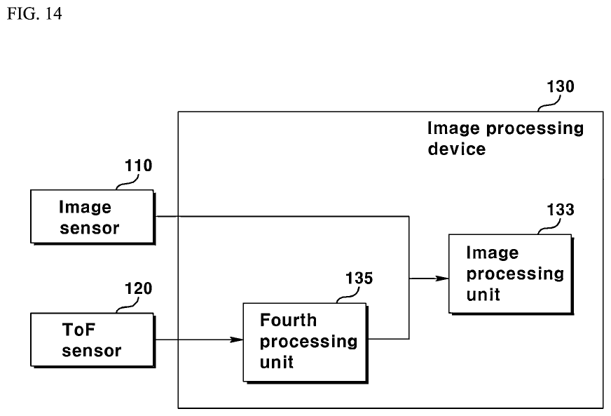

An image processing device may be configured in an embodiment different from the image processing device according to the embodiment of the present invention shown in FIG. 1. FIG. 12 is a block diagram of an image processing device according to another embodiment of the present invention; FIG. 13 is a diagram illustrating an image processing process of an image processing device according to another embodiment of the present invention; FIG. 14 is a block diagram of an image processing device according to another embodiment of the present invention; and FIG. is a diagram illustrating an image processing process of an image processing device according to another embodiment of the present invention. A detailed description of each configuration of the image processing device 130 according to the embodiment of FIGS. 12 and 14 corresponds to a detailed description of a configuration having the same reference number as that of the image processing device 130 according to the embodiment of FIG. 1. Therefore, the overlapping description hereinafter will be omitted.

An image processing device 130 according to another embodiment of the present invention includes a third processing unit 134 and an image processing unit 133 as shown in FIG. 12.

The third processing unit 134 generates second Bayer data having a second resolution from the first Bayer data having a first resolution, and second IR data having a fourth resolution from the first IR data having a third resolution.

More specifically, compared to the image processing device 130 according to the embodiment of FIG. 1 being composed of the first processing unit 131 and the second processing unit 132, the image processing device 130 according to the embodiment of FIG. 12 is composed of a third processing unit 134, so that it can process the processes performed by the first processing unit 131 and the second processing unit 132 in the third processing unit 134.

To this end, as shown in FIG. 13, the third processing unit 134 receives the first Bayer data from the image sensor 110 and receives the first IR data from the ToF sensor 120. The third processing unit 134 generates second Bayer data having a second resolution from the first Bayer data having a first resolution, and second IR data having a fourth resolution is generated from the first IR data having a third resolution.

When generating the second Bayer data, the third processing unit 134 performs deep learning using the first deep learning parameter 134-2 derived through training on Bayer data processing, and when generating the second IR data, deep learning may be performed using the second deep learning parameter 134-3 derived through training on IR data processing.

The third processing unit 134 generates second Bayer data and second IR data using one deep learning network. Even if the same deep learning network is used, since the parameters of the deep learning model for generating the second Bayer data and the second IR data are different, the third processing unit 134 stores both a first deep learning parameter derived through training on Bayer data processing and a second deep learning parameter derived through training on IR data processing.

In addition, because it uses one deep learning network, and since the second Bayer data and the second IR data cannot be generated at the same time, the third processing unit 134 may perform the second Bayer data generation and the second IR data generation by time division. By dividing time sequentially, generation of second Bayer data and generation of second IR data may be performed. At this time, the second Bayer data generation or the second IR data generation corresponding to one frame is divided and processed, or in the case of using the line buffer, the generation of the second Bayer data and the generation of the second IR data may be performed by time division according to processing for each line in consideration of the time required to store the data of the required number of lines in the line buffer.

The image processing unit 133 generates a second RGB image by calculating the first RGB image generated from the second Bayer data and the IR image generated from the second IR data. The second Bayer data generated by the third processing unit 134 is processed through the image in the image processing unit 133, as shown in FIG. 13, and a first RGB image is generated (133-1), and the second IR data is used to generate an IR image (133-2) and a depth image (133-3) in the image processing unit 133. The generated IR image is used to generate a second RGB image with improved image quality (133-1) through calculation with the first RGB image.

An image processing device 130 according to another embodiment of the present invention is composed of a fourth processing unit 135 and an image processing unit 133 as shown in FIG. 14.

The fourth processing unit 135 generates second IR data having a fourth resolution from the first IR data having a third resolution.

More specifically, compared to the image processing device 130 according to the embodiment of FIG. 1 being composed of the first processing unit 131 and the second processing unit 132, the image processing device 130 according to the embodiment of FIG. 12 is composed of a fourth processing unit 135, and the fourth processing unit 135 may process processes performed by the second processing unit 132. The process of generating the second Bayer data from the first Bayer data by the first processing unit 131 of the image processing device 130 according to the embodiment of FIG. 1 is not performed.

Without resolution conversion on Bayer data, only resolution conversion on IR data is performed. As described above, since the size of IR data is generally smaller than that of Bayer data, it is important to increase the resolution of IR data. That is, even if it is not necessary to increase the resolution of the Bayer data, it is necessary to increase the resolution of the IR data in order to improve the quality of the RGB image generated from the Bayer data. Accordingly, the fourth processing unit 135 generates the second IR data having a fourth resolution from the first IR data having a third resolution.

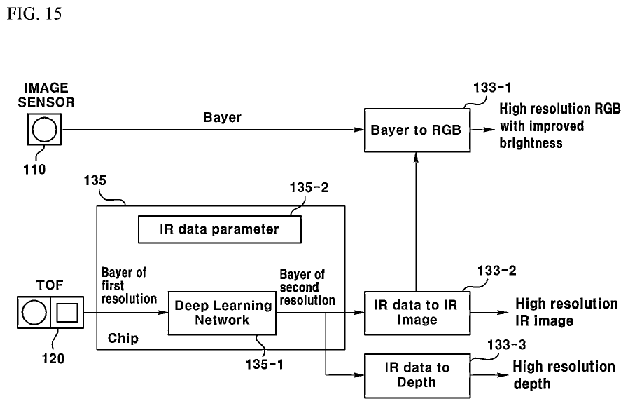

To this end, the fourth processing unit 135 receives the first IR data from the ToF sensor 120 as shown in FIG. 15, and generates the second IR data having a fourth resolution from the first IR data having a third resolution. The configuration and function of the fourth processing unit 135 may be substantially the same as those of the second processing unit 132 of FIG. 1. Deep learning may be performed using a second deep learning parameter 135-2 derived through training on IR data processing through a deep learning network 135-1.

The image processing unit 133 generates a second RGB image by calculating the first RGB image generated from the Bayer data and the IR image generated from the second IR data. The Bayer data generated and outputted from the image sensor 110 is processed by the image processing unit 133 to generate a first RGB image (133-1) as shown in FIG. 15, and the second IR data is used in the image processing unit 133 to generate the IR image (133-2) and the depth image (133-3). The IR image that has been generated is used to generate (133-1) a second RGB image with improved image quality through calculation with the first RGB image.

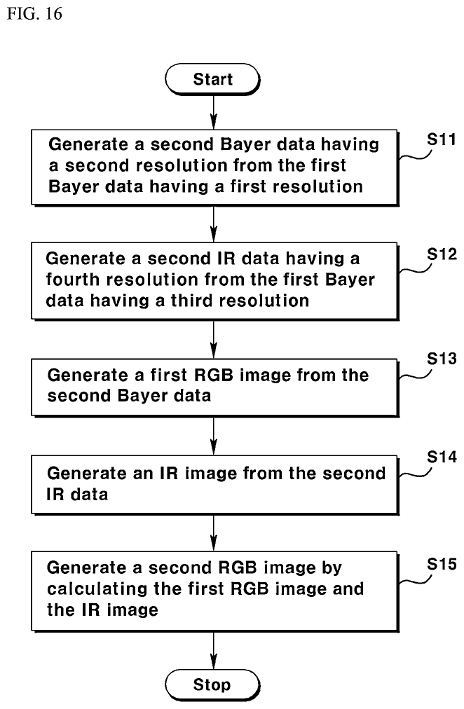

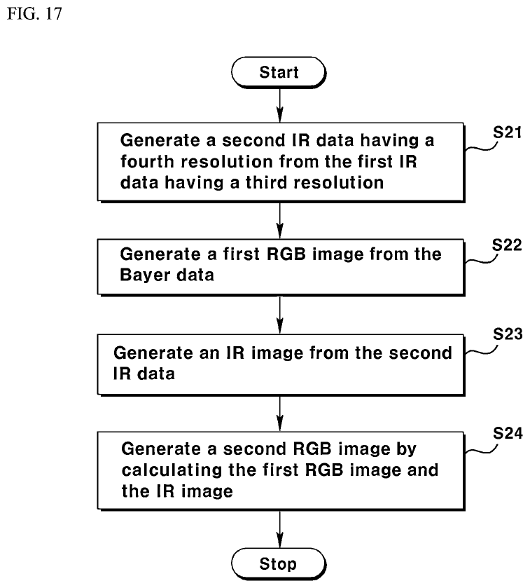

FIG. 16 is a flowchart of an image processing method according to an embodiment of the present invention, and FIG. 17 is a flowchart of an image processing method according to another embodiment of the present invention. A detailed description of each step of FIGS. 16 to 17 corresponds to a detailed description of the image processing device 130 of FIGS. 1 to 15. In particular, the detailed description of FIG. 16 corresponds to the detailed description of the image processing device 130 of FIGS. 1 to 11 and FIGS. 14 to 15, and the detailed description of FIG. 17 corresponds to the detailed description of the image processing device 130 of FIGS. 12 and 13. Hereinafter, overlapped descriptions will be omitted.

An image processing method according to an embodiment of the present invention relates to a method for processing an image in an image processing device including one or more processors.

In step S11, second Bayer data having a second resolution is generated from the first Bayer data having a first resolution, and in step S12, second IR data having a fourth resolution is generated from the first IR data having a third resolution. Steps S11 and S12 may be performed simultaneously, or any step may be performed first. Or, it may be performed according to the time at which Bayer data or IR data is received from the image sensor or the ToF sensor. Step S11 may be performed using a first convolutional neural network trained to output the second Bayer data from the first Bayer data. Deep learning may be performed to generate the second Bayer data having a second resolution from the first Bayer data having a first resolution. In addition, step S12 may be performed using a second convolutional neural network trained to output second IR data from the first IR data. Deep learning may be performed to generate second IR data having a fourth resolution from the first IR data having a third resolution. The method may further include receiving the first Bayer data from the image sensor or receiving the first IR data from the ToF sensor.

Thereafter, a first RGB image is generated from the second Bayer data in step S13, and an IR image is generated from the second IR data in step S14. Steps S13 and S14 may be performed simultaneously, or either step may be performed first. Or, it may be performed according to a time when the second Bayer data or the second IR data is generated.

Thereafter, in step S15, a second RGB image is generated by calculating the first RGB image and the IR image. Through this, it is possible to generate an image with high resolution and an RGB image with improved image quality at the same time.

The image processing method according to the embodiment of FIG. 17 relates to a method of processing an image in an image processing device including one or more processors.

In step S21, second IR data having a fourth resolution is generated from the first IR data having a third resolution. Unlike the embodiment of FIG. 16, the step of generating the second data from the first Bayer data is not included. Step S21 may be performed using a second convolutional neural network trained to output the second IR data from the first IR data. Deep learning may be performed to generate second IR data having a fourth resolution from the first IR data having a third resolution.

Then, in step S22, a first RGB image is generated from Bayer data, and in step S23, an IR image is generated from the second IR data. Steps S22 and S23 may be performed simultaneously, or any step may be performed first. Or, it may be performed according to a time at which Bayer data is received from the image sensor or a time at which the second IR data is generated.

Thereafter, in step S24, the first RGB image and the IR image are calculated to generate a second RGB image. Through this, it is possible to generate an RGB image with improved image quality.

Meanwhile, the embodiments of the present invention can be implemented as computer readable codes on a computer readable recording medium. The computer readable recording medium includes all types of recording devices in which data readable by a computer system is stored.

As for examples of computer readable recording media, there are ROM, RAM, CD-ROM, magnetic tape, floppy disk, and optical data storage device; in addition, the computer readable recording medium is distributed over networked computer systems; and computer readable code can be stored and executed in a distributed manner. In addition, functional programs, codes, and code segments for implementing the present invention can be easily inferred by programmers in the technical field to which the present invention belongs.

As described above, in the present invention, it has been described with specific matters such as specific components and limited embodiments and drawings, but these are only provided to help a more general understanding of the present invention, the present invention is not limited to the above embodiments, and various modifications and variations are possible from these descriptions by those skilled in the art to which the present invention belongs.

Therefore, the spirit of the present invention should not be limited to the described embodiments, and not only the claims to be described later, but also all those with equivalent or equivalent modifications to the claims will be said to belong to the scope of the spirit of the present invention.

1. An image processing device comprising:
a first processing unit configured to output a second Bayer data having a second resolution from a first Bayer data having a first resolution;
a second processing unit configured to output a second IR data having a fourth resolution from a first IR data having a third resolution; and
an image processing unit configured to output a second RGB image by calculating a first RGB image generated from the second Bayer data and an IR image generated from the second IR data.

2. The image processing device according to claim 1, wherein the first processing unit comprises a first convolutional neural network that has been learned to output the second Bayer data from the first Bayer data.

3. The image processing device according to claim 1, wherein the second processing unit comprises a second convolutional neural network that has been learned to output the second IR data from the first IR data.

4. The image processing device according to claim 1, wherein the first Bayer data is data being outputted from an image sensor and the first IR data is data being outputted from a ToF sensor.

5. The image processing device according to claim 4, wherein a frame rate per hour of the ToF sensor is faster than a frame rate per hour of the image sensor.

6. The image processing device according to claim 1, wherein the image processing unit generates the second RGB image by using a result value calculated by calculating the reflection component of the first RGB image and the IR image, and hue component and chroma component of the first RGB image.

7. The image processing device according to claim 1, wherein the first processing unit outputs the second Bayer data from the first Bayer data using a first parameter derived through training on Bayer data processing, and
wherein the second processing unit outputs the second IR data from the first IR data using a second parameter derived through training on IR data processing.

8. The image processing device according to claim 1, wherein the first processing unit and the second processing unit are formed on an image sensor module, a camera module, or an AP module.

9. The image processing device according to claim 1, wherein the second resolution is higher than the first resolution, and the fourth resolution is higher than the third resolution

10. The image processing device according to claim 1, wherein the second resolution and the fourth resolution are same.

11. The image processing device according to claim 1, wherein the image processing unit corrects the IR image before performing the operation with the first RGB image.

12. The image processing device according to claim 1, wherein the image processing unit generates the first RGB data from the second Bayer data, and generate the IR image from the second IR data.

13. The image processing device according to claim 1, wherein the IR image generated by the image processing unit is an amplitude image or an intensity image generated from the second IR data according to four different phases being generated by the second processing unit.

14. The image processing device according to claim 1, wherein the first processing unit comprises at least one line buffer configured to store the first Bayer data for each line, and
wherein when first Bayer data of a predetermined number of lines is stored in the line buffer, the first processing unit generates second Bayer data for the first Bayer data stored in the line buffer.

15. An image processing device comprising:
a third processing unit configured to generate a second Bayer data having a second resolution from a first Bayer data having a first resolution, and generate a second IR data having a fourth resolution from a first IR data having a third resolution; and
an image processing unit configured to generate a second RGB image by calculating a first RGB image being generated from the second Bayer data and an IR image being generated from the second IR data.

16. The image processing device according to claim 15, wherein the third processing unit comprises a convolutional neural network that has been learned to output the second Bayer data from the first Bayer data.

17. The image processing device according to claim 15, wherein the third processing unit comprises a convolutional neural network that has been learned to output the second IR data from the first IR data.

18. The image processing device according to claim 15, wherein the third processing unit outputs the second Bayer data from the first Bayer data using a first parameter derived through training on Bayer data processing, and
wherein the third processing unit outputs the second IR data from the first IR data using a second parameter derived through training on IR data processing.

19. The image processing device according to claim 15, wherein the third processing unit generates the second Bayer data and the second IR data by performing by time division multiplexing.

20. An image processing method comprising:
generating a second Bayer data having a second resolution from a first Bayer data having a first resolution;
generating a second IR data having a fourth resolution from a first IR data having a third resolution;
generating a first RGB image from the second Bayer data;
generating an IR image from the second IR data; and
generating a second RGB image by calculating the first RGB image and the IR image.
